(19) United States
(12) Patent Application Publication
(10) Pub. No.: US 2023/0194900 A1
(43) Pub. Date: Jun. 22, 2023

(54) Opthalmic Guard

(71) Applicant: LaTorr Holding LLC, Chino, CA (US)

(72) Inventors: Daisy Landeros, Chino, CA (US); Adrian Torres, Chino, CA (US); Sam Ristich, Los Angeles, CA (US)

(21) Appl. No.: 17/385,760

(22) Filed: Jul. 26, 2021

(51) Int. Cl. G02C 11/00; G02C 5/14

(52) U.S. Cl. CPC G02C 11/12; G02C 5/14; G02C 2200/02

(57) ABSTRACT

The present invention relates to a low-cost, magnetically detachable, durable, and flexible opthalmic shield for use with customized eyeglasses or eye goggles. It provides a seal between both the shield and the eyeglass frames, and between the shield and a user’s face to adequately protect the user’s eyes from particulates, allergens, and other environmental factors.

### FIELD OF THE INVENTION

Embodiments of the present invention generally relate to improved wearable opthalmic protection. More particularly, this disclosure pertains to eyewear having a deformable shield member that is selectively removable and protects the wearer’s eyes from wind and environmental factors.

### DESCRIPTION OF THE RELATED ART

The invention relates to a detachable, flexible, and durable opthalmic guard usable with specialized eyeglasses or goggles. Shields that protect a wearer’s eyes from environmental factors are available but have many problems. Many must be permanently secured to the underlying eyeglasses or goggles to function, thus limiting usability and portability of the eyeglasses. Many protective shields are bulky and do not flow naturally from the form of the rigid eyewear frame to securely seal against the wearer’s skin. Further, current fully-sealing eye shields are comprised of a single material which means a compromise in either shield rigidity or a wearer’s comfort at the point of contact between the guard and the wearer’s skin. Comfort may be obtained in some cases from the use of a softer material for the guard, but then the guard must be bulky enough to be durable and to account for movement when worn. Current guards often impair the vision of the wearer and interfere with the operation of temple pieces and tips, as they fit over and around the eyeglasses’ rigid frame. Many other shields do not actually seal tightly against a wearer’s face, allowing environmental factors — e.g. allergens, pollen, dust, sand, etc. — to move around and through the gaps between the shield and the wearer’s face and into their eyes. Shields that do seal may not vent properly and thus do not prevent lenses from fogging and consequently impairing the wearer’s vision. Examples of previous opthalmic guards bearing some or all of these problems are disclosed in the following:

U.S. Pat. No. 4,785,481 discloses protective eyeglass shields for medical professionals to prevent contact with liquid-transmittable contagions. The flexible shields disclosed therein are preferably air-permeable to prevent fogging of the lenses. However, the shield pieces are not removable or detachable from the frame, they are not continuous, and they are not described as providing a customizable fitment onto the wearer’s face to ensure a tight yet comfortable seal.

U.S. Pat. No. 5,300,963 shows a protective hood made of soft resin material heat molded to the eyeglasses frame when, during heating, some of the resin material fills grooves in the frame. Thus, the protective eye hood is not removably joined to the frame, and is not described as air-permeable. Further, the resin material formed onto the frame via heat molding is of a single durometer hardness, thus requiring a compromise in structural stiffness of the hood in order to maintain a comfortable fitment on a wearer’s face.

U.S. Pat. No. 5,339,119 discloses a protective eyeglass cover made of air-permeable foam, which provides air circulation to minimize lens fogging. However, the cover encases the eyeglass frame, excepting the earpieces which are inserted through apertures in the cover to hold it in place. The cover is only held in place by the clamping effect between the earpieces and the head and support from the frame. Cover attachment is unsecured by independent magnetization, and the cover itself does not include a secondary softer overmolded interface for more precise and comfortable fitment for a wearer.

U.S. Pat. No. 5,548,351 discloses protective eyeglass shields coupled to is eyeglass frames by the engagement of the earpieces with a longitudinally extending channel formed in each shield. The shields are non-reversibly attached to the eyeglasses by the insertion of pin into an opening that locks the shield to the earpiece. The shields are not described as air-permeable and provide protection only peripherally.

U.S. Pat. No. 5,243,711 discloses an integral shield and lens-piece, where the shield is made of plastic foam, primarily for use during hair styling to protect the wearer from hair spray. The shield is not removable and does not incorporate an overmolded softer guard-to-skin interface region for more precise and comfortable fitment for a wearer.

U.S. Pat. No. 5,388,269 shows a protective eyeglass shield with slots formed in the shields for support from the earpieces of an eyeglasses frame. The shield is not described as air-permeable, protects only peripherally, does not incorporate magnetic removability, and does not include an overmolded softer guard-to-skin interface region for more precise and comfortable fitment for a wearer.

U.S. Pat. No. 5,614,963 shows an eyeglass shield which is detachably mounted to an eyeglasses frame by posts which engage holes in the eyeglasses frame. It is not described as air-permeable, it does not have easy magnetic removal or attachment via seamlessly-integrated magnets, and does not fit snugly against the face to protect against environmental factors such as allergens.

U.S. Pat. No. 6,062,688 discloses a magnetically-detachable eyeglass foam shield. The eye shielding system described therein permits an air-permeable shield to be releasably secured to the frame of eyeglasses or goggles, but does not include magnets in the hinged temple pieces to ensure lateral stability of the shield upon installation and use. The shield itself is formed from an air-permeable foam so as to prevent fogging, but is not deformable and foldable such that the shield will return to its original shape after being folded for transportation and/or storage. Further, the shield does not include an overmolded soft contact interface with the user’s face formed from a different material than the protective lobes of the shield itself. This means the foam shield must be soft enough to be worn comfortably and thus not hard enough to seal strongly against the skin and frame to limit smaller airborne allergen particulates or protect against the intrusion of larger objects near the user’s eyes.

U.S. Pat. No. 7,296,887 discloses a pair of windproof glasses having a frame assembly and a separate windproof shield assembly. The disclosed windproof shield assembly is mounted detachably on the frame assembly via magnets. The shield does not provide a complete protective encasement around the wearer’s eyes to protect against environmental factors and incorporates a rigid contiguous structure that cannot be collapsed or folded when removed for storage without permanent deformation or breaking. Further, there is no magnetic attachment to the eyeglass frame temple pieces to ensure the shield can be quickly and consistently removed and installed.

The foregoing do not meet all of the needs of eyeglass wearers that need an easily-removable guard that prevents eye exposure to wind and environmental factors (e.g. allergens). It is against this background that the devices described herein have been developed. The present invention overcomes all of the inherent deficiencies and limitations of the prior art devices. It is rapidly detachable, easily and consistently attachable, flexible, durable, may be disposed of after use, fits snugly, comfortably seals against the face for long term use, protects against airborne environmental factors, is vented to preventing lens fogging, and approximately the same profile as the rigid frame of the eyeglass or goggles thus reducing its size and bulkiness. It does not interfere with vision or with the fit of the glasses.

This invention is unique because it uses a detachable, vented, dual-material hypoallergenic shield that is removably attached to the rigid frames of glasses or goggles via magnets to allow for quick installation and removal, and because it fits snugly and seals against the wearer’s face. The total assembly is lightweight, durable, flexible, made of low-cost materials, and may be easily custom-fitted for each wearer.

The opthalmic guard system, described in various embodiments herein, includes a guard shield that fits firmly, snugly, and removably onto the skin-facing side of rigid eyewear frames containing embedded magnets. The guard shield is made in part of a flexible hypoallergenic material that does not degrade into fine particulates, allows for venting to reduce condensation on any sealed inner lens surfaces, and includes an overmolded secondary material on the edge of the guard shield that contacts the wearer’s skin. The softer overmolded interface provides a tight yet comfortable seal while still allowing use of a more durable and rigid shield material that can withstand more abuse and be mounted more securely between the rigid eyewear frame and user’s face. Thus, a wearer may continuously and comfortably use the guard system for longer periods of time, with less concern for guard deterioration or deformation, and with improved environmental protection.

### SUMMARY OF THE INVENTION

One or more embodiments of the invention are directed to improved wearable opthalmic protection or guard.

This invention provides a low-cost, detachable, durable, and flexible shield for use with customized eyeglasses or eye goggles. It provides a sufficiently snug fit or seal between both the shield and the eyeglass frames, and between the shield and the face to adequately protect the eyes from particulates, allergens, and other environmental factors. This invention includes the guard shield itself, which can come in different variations, and may include a set of specialized eyeglasses or goggles modified to accept a shield of this invention.

A first function is that it protects the eyes from environmental factors, which means that it must fit snugly to both the face and the frame of the eyeglasses or goggles, thus creating a seal to exclude materials from the eyes. Another function of this invention is that the shield permit air to be vented to inhibits condensation forming on interior lens surfaces. Another function of this invention is that despite being securely and tightly fitted between the rigid frame (in part with magnets) and the wearer’s face (via contact with an overmolded softer interface seal), the guard shield is readily removable and itself flexible for reuse, ease of installation, transportation, and storage. Thus, the modified eyeglasses bearing embedded magnets may be worn without the guard shield, while also not appearing noticeably different from an ordinary pair of eyeglasses. One desire is that the shield itself be of low cost, which means that it can be easily replaceable and produced in larger quantities (such that a wearer may be able to easily carry multiple shields for stylistic or practical reasons). A further desire is that the system be easy to use and comfortable for extended periods of wear. There is nothing in the prior art that meets all of these objectives.

The further scope of this invention will become apparent upon the review of the detailed description of the preferred embodiments. It should however be understood that these descriptions do not limit the scope of the invention and are given as examples only, and that various changes and modifications which are fully within the scope of the present invention will become apparent to those skilled in the art.

### BRIEF DESCRIPTION OF THE DRAWINGS

The above and other aspects, features and advantages of the invention will be more apparent from the following more particular description thereof, presented in conjunction with the following drawings wherein:

FIG. 1 is a front exploded perspective view of one embodiment of the present invention.

FIG. 2 is a rear perspective of the embodiment of the present invention first shown in FIG. 1.

FIG. 3. is a top view of the embodiment of the present invention first shown in FIG. 1.

FIG. 4 is a front perspective view of an embodiment of the removable guard member alone which in part comprises the embodiment of the present invention first shown in FIG. 1.

FIG. 5 is a front exploded perspective view of another embodiment of the present invention.

FIG. 6 is a rear perspective of the embodiment of the present invention first shown in FIG. 5.

FIG. 7 is a top view of the embodiment of the present invention first shown in FIG. 5.

FIG. 8 is a front perspective view of an embodiment of the removable guard member alone which in part comprises the embodiment of the present invention first shown in FIG. 5.

### DETAILED DESCRIPTION

The present invention comprising improved wearable opthalmic guard will now be described. In the following exemplary description numerous specific details are set forth to provide a more thorough understanding of embodiments of the invention. It will be apparent, however, to an artisan of ordinary skill that the present invention may be practiced without incorporating all aspects of the specific details described herein. Specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a nonlimiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, 10, and ranges in between” can include 1-1, 1-3, 2-10, etc. Similarly, “1, 5, 10, 25, 50, 70, 95, or ranges including and or spanning the aforementioned values” can include 1, 5, 10, 1-5, 1-10, 10-25, 10-95, 1-70, etc.

Unless otherwise defined expressly, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

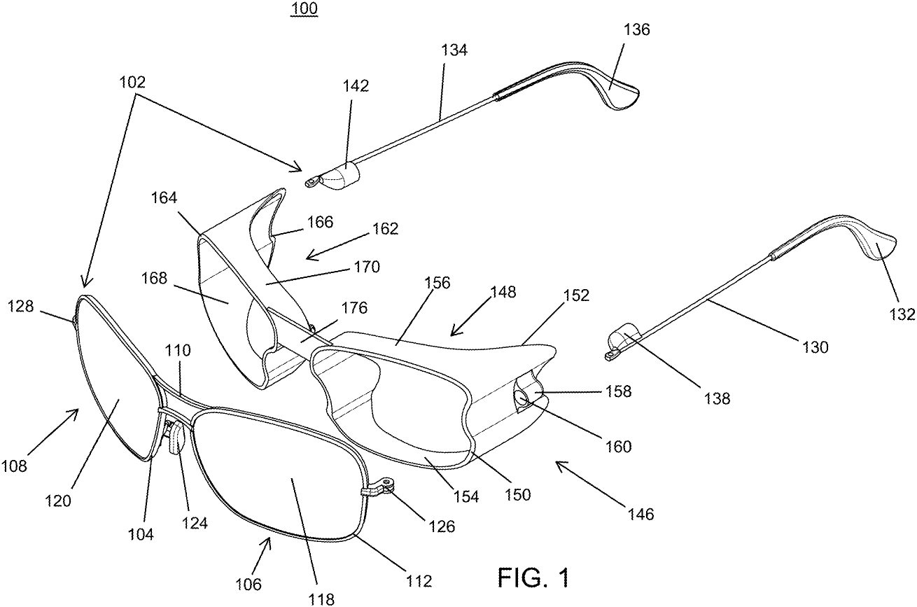

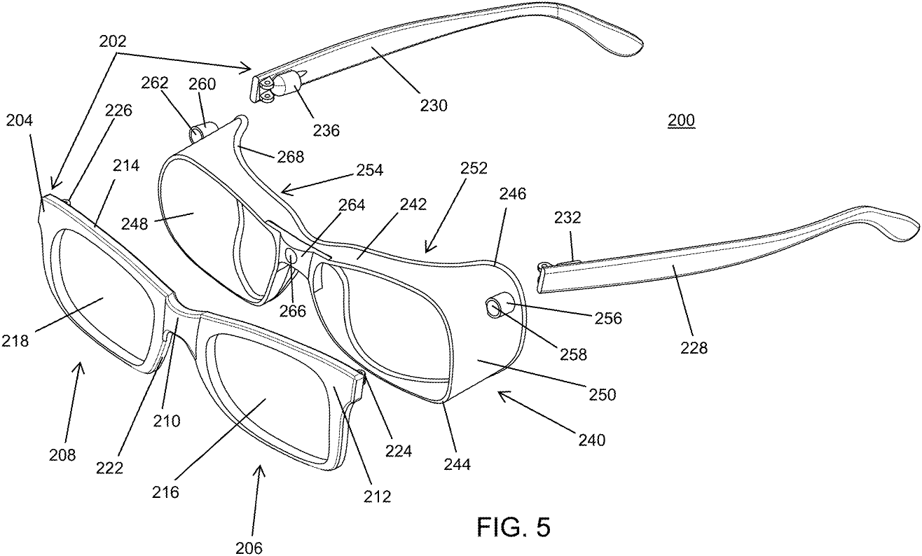

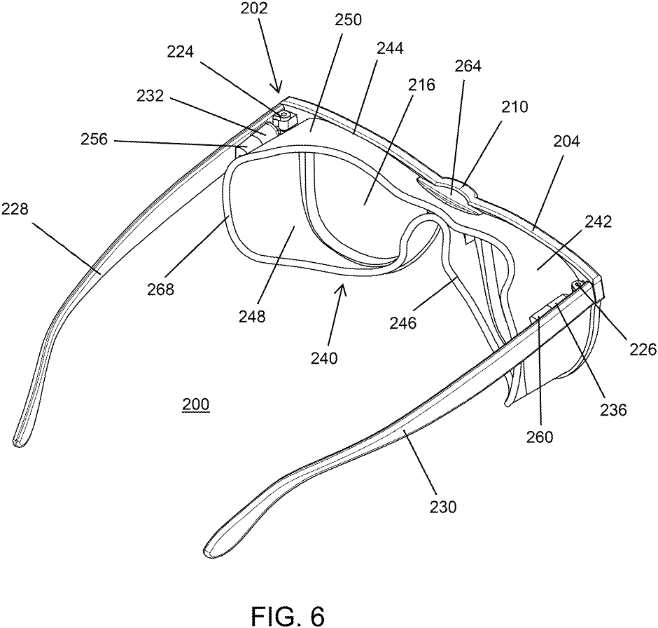

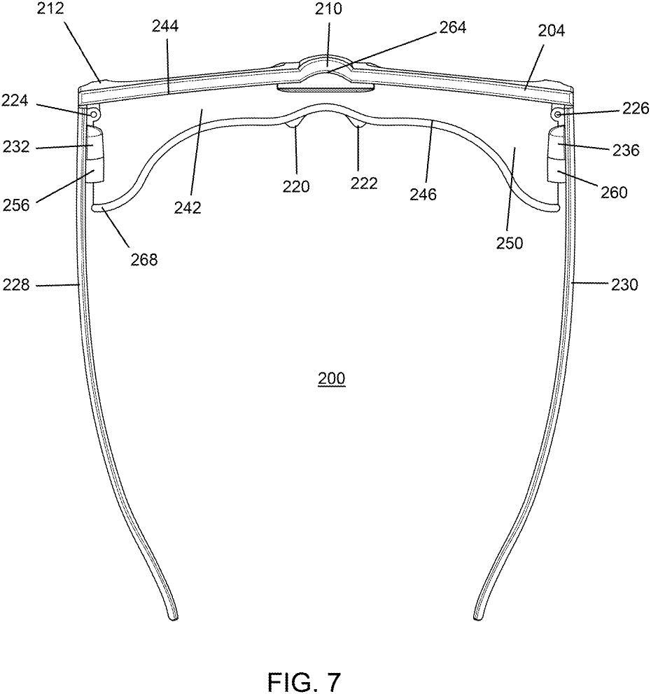

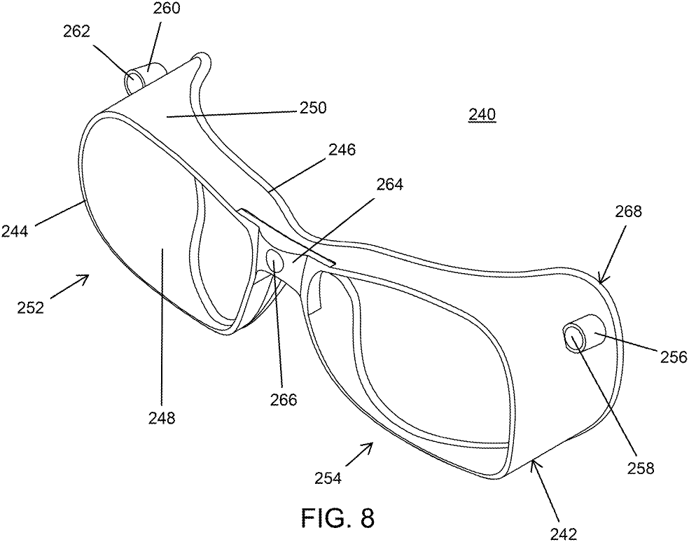

One or more embodiments of the present invention will now be described with references to FIGS. 1-8. FIGS. 1 through 4 provide varying views of one embodiment of the present invention. FIGS. 5 through 8 provide varying views of another embodiment of the present invention.

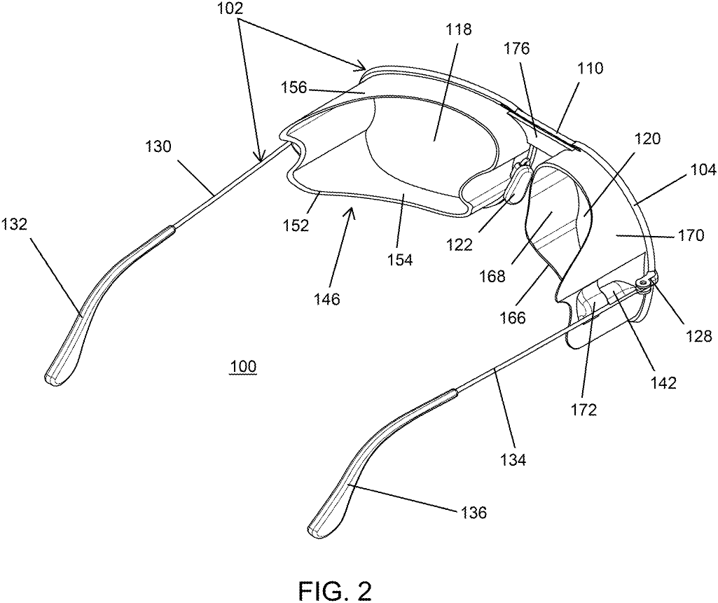

FIG. 1 is a front exploded perspective view showing an eyewear guard device 100 formed from an eyeglass assembly 102 and a removable opthalmic guard 146. The eyeglass assembly is formed from a rigid frame 104, which itself has a left lens opening 106, right lens opening 108, and a bridge 110. The front surface 112 of the rigid frame 104 faces out and away from a user’s face, when the eyewear guard device 100 is worn. The rear surface 114 (FIG. 2) is opposite the front surface 112 and faces toward the user’s face. There is a left lens 118 secured within the left lens opening 104, and a right lens 120 secured within the right lens opening 120. The rigid frame 104 incorporates a left nose pad 122 (FIG. 2), and a right nose pad 124 such that the weight of the eyewear guard device 100 is securely supported and distributed over a greater surface area on the wearer’s nose. The rigid frame 104 is formed from a durable material (e.g., plastic, metal, wood, acrylic, ceramic, etc.) that limits unwanted flex and provides a sturdy base upon which the removable opthalmic guard 146 can be mounted and seal against.

At the left and right lateral extremes of the rigid frame 104, lie the left hinge 126, and right hinge 128, respectively. The left hinge 126 rotatably couples the elongate left temple piece 130 to the rigid frame 104, while the right hinge 128 does the same for the elongate right temple piece 134. The elongate left temple piece 130 terminates on the end opposite the left hinge 126 with a left temple tip 132, which is shown as a curved padded section and that acts as another contact point with the wearer’s head in order to securely support and distribute the weight of the eyewear guard device 100 over a larger surface area. The elongate right temple piece 134 terminates in a right temple tip 136, which is a mirror copy in form and function of the left temple tip 132.

The elongate left temple piece 130 includes a securely fixed left magnet housing 138 near the left hinge 126 that protrudes away from the piece 130 and toward the wearer’s head, formed of substantially the same material as the elongate left temple piece 130. The left magnet housing 138 houses an embedded left temple magnet 140, which can be a magnet of varying compositions or materials shaped to fit within the housing 138 (e.g., flexible lightweight, high energy flexible, ceramic, neodymium, other rare earth magnets, etc.). The strength of the embedded left temple magnet 140 can vary depending on both practical and aesthetic design considerations but should be oriented in opposing polarity to the left guard magnet 162 to enable a firm and secure magnetic attachment when brought into contact with one another. The elongate right temple piece 132 includes a securely fixed right magnet housing 142 that protrudes away from the piece 132 and toward the wearer’s head, which itself is mirrored in form to the left magnet housing 138. As with the left magnet housing 138, the right housing 142 includes an embedded right temple magnet 144 oriented in opposing polarity to a right guard magnet 174.

The removable opthalmic guard 146 is formed from a flexible left shield 148, flexible right shield 162, and flexible bridge 176. The flexible bridge shown in FIGS. 1-4 is substantially flat, but in an alternative embodiment can include a hinge element (e.g., a live hinge, joined swivel hinge, etc.) that facilitates folding and storage of the removable opthalmic guard 146 when detached from the eyeglass assembly 102. The flexible left shield 148 is a substantially oblong rounded shape matching the two-dimensional profile of the shape of the left lens opening 106 and left lens 118. The same applies for the flexible right shield 162, right lens opening 108, and right lens 118. Thus, the removable opthalmic guard 146 appears sleek, not bulky, and when viewing the eyewear guard device 100 head-on toward the front surface 112, does not appear to protrude beyond the contours of the rigid frame 104.

The flexible left shield 148 further includes a proximate edge 150 shaped to seal securely upon the rigid frame 104, a distal edge 152 shaped to seal securely upon a wearer’s face, an inner surface 154, and an outer surface 156. In the present embodiment, flexible left shield 148 includes a scalloped region to accommodate a left magnet mount 158 that includes an embedded left guard magnet 160. In an alternative embodiment the left magnet mount 158 may be mounted onto the outer surface 156 without changing the cross-sectional profile of the flexible left shield 148. The left magnet mount 158 is further positioned such that the embedded left guard magnet 160 becomes aligned with the left temple magnet 140 upon installation of the removable opthalmic guard 146 within the eyewear guard device 100. The flexible right shield 162 mirrors the form and composition of the flexible right shield 148, and itself includes a proximate edge 164, distal edge 166, inner surface 168, outer surface 170, and right magnet mount 172 with embedded right guard magnet 174. The left guard magnet 160 and right guard magnet 174 can be formed from varying compositions or materials (e.g., flexible lightweight, high energy flexible, ceramic, neodymium, other rare earth magnets, etc.). The flexible left shield 148 and flexible right shield 162 include scalloped inner regions to avoid any overlap with the left nose pad 122 and right nose pad 124, respectively. This further promotes the aesthetic and practical need for sleekness, useability, and comfort of the eyewear guard device 100.

FIG. 1 exhibited an exploded perspective view to aid the reader in understanding the structure of the eyewear guard device 100 components separately. FIG. 2 shows a rear perspective view of the eyewear guard device 100 as it would appear with the removable opthalmic guard 146 installed on the rear surface 114 of the rigid frame 104 of the eyeglass assembly 102. As seen in this FIG. 2, the left and right magnet housings — 138 and 142, respectively — align with the left and right magnet housings — 158 and 172, respectively — such that the left-side magnets — 140 and 160 — and right-side magnets — 144 and 174 — closely align and securely fasten together. The proximate edge of the flexible left shield 150 and right shield 164 are not visible but form a seal against the now partially-obscured rigid frame 104 where it contacts the left lens 118 and right lens 120 at the left lens opening 106 and right lens opening 108.

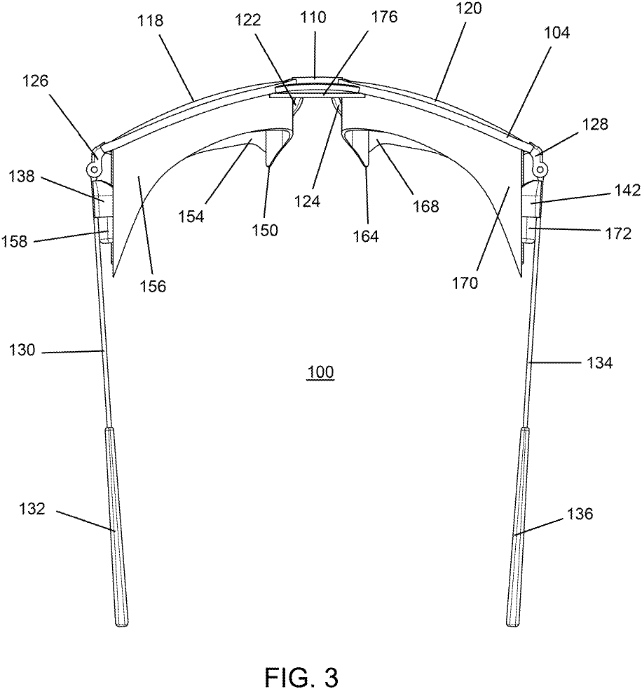

FIG. 3 is a top view of the same embodiment of the eyewear guard device 100, and clearly shows the close sealing alignment of the removable opthalmic guard 146 against the rigid frame 104, as facilitated by the precise alignment of the left and right magnet housings — 138 and 142, respectively — with the left and right magnet housings -158 and 172, respectively. This view also more clearly illustrates the contoured curvature of the distal edges of the left and right flexible shields — 152 and 166, respectively. The curvature may be customized to fit a wearer particularly, but can also be designed with generalized sizing options in mind, or for universal applicability and fitment.

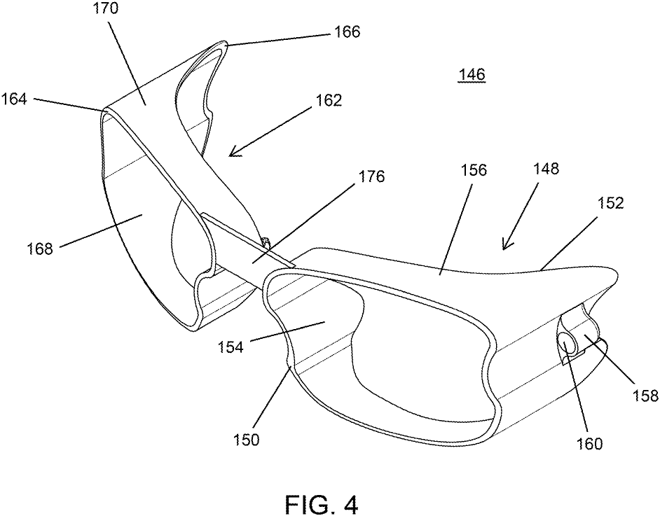

FIG. 4 is a front perspective view of only the removable opthalmic guard 146. Both the flexible left shield 148 and right shield 162 are comprised of a durable yet flexible hypoallergenic material capable of maintaining its structure when pressed between the rigid frame 104 and wearer’s face, while also maintaining comfort during use. The seal provided by the shields further promotes the underlying purpose of the device 100, by protecting the wearer’s eyes from wind and environmental particulates such as dust, sand, moisture, and other allergens. Given their substantially cylindrical shape, the left shield 148 and right shield 162 can flexibly deform for storage when the force or a pinch is applied perpendicularly to the outer surfaces 156 and 170 but is strong enough to maintain its shape withstand deformation from wind. The flexible yet durable material forming the left shield 148, right shield 162, and flexible bridge 176, allows the removable opthalmic guard 146 to be compacted for storage and transportation without worry that the folds and compaction will leave a lasting deformation or deterioration of the overall guard’s 146 shape when deployed and installed on the eyeglass assembly 102. In an alternative embodiment, a filtered vent may be present and oriented within each of the left 148 and right 162 shields, such that condensation formation may be abated on the left 118 and right 120 lenses while still preventing exposure to environmental particulates and excessive wind.

FIG. 5 is a front exploded perspective view showing another embodiment of the invention as an opthalmic protector 200 formed from an sunglass assembly 202 and a removable eye guard 240. The sunglass assembly 202 is formed from a frame 204, which itself has a left lens opening 206, right lens opening 208, and a bridge 210. Although aesthetically different, the components of the sunglass assembly 202 shown in FIGS. 5-7 is substantially similar in structure to the eyeglass assembly 104 shown in FIGS. 1-3. The sunglass assembly includes a left lens opening 206, right lens opening 208, front surface 212, and rear surface 214. One key difference is that the structure of the bridge 210 is a contiguous portion of durable material (the same material comprising the frame 204), instead of the over/under wire design of the eyeglass bridge 110 (FIGS. 1-3). This allows for the hidden installation of an embedded center docking magnet (not shown) within the frame 204 that bolsters mounting stability and improves alignment of the removable eye guard 240.

The sunglass assembly 202 further includes a left lens 216, right lens 218, left nose contact 220, right nose contact 222, left hinge 224, and right hinge 226. A left temple arm 228 is movably coupled to the frame 204 at the left hinge 224, such that the arm 228 can swivel between a collapsed stated and an opened state where the arm 228 extends substantially perpendicularly from the rear surface 214. A right temple arm 230 mirrors the left temple arm 228 and is coupled to the frame 204 at the right hinge 226. The temple arms 228 and 230 terminate with a contoured curvature designed to improve fitment on and around a wearer’s ears. The left temple arm 228 further includes a left magnetic housing 232 mounted near the left hinge 226 on the surface of the arm 228 facing the skin of the wearer’s face. The left magnetic housing 232 includes an embedded left magnet 234 of varying compositions or materials (e.g., flexible lightweight, high energy flexible, ceramic, neodymium, other rare earth magnets, etc.). The right temple arm 230 includes a mirrored right magnetic housing 236 and embedded right magnet 238. As with the rigid frame 104 (FIGS. 1-3), the frame 204 may be formed from a durable material (e.g., plastic, metal, wood, acrylic, ceramic, etc.) that limits unwanted flex and provides a sturdy base upon which the removable removable eye guard 240 can be mounted and seal against.

The embodiment shown in FIGS. 5-8 is mainly distinct from that shown in FIGS. 1-4, because of the differences in structure between the removable eye guard 240 and removable opthalmic guard 146. The removable eye guard 240 does not include two distinct shield regions, each with their own sealed spaces around the left and right eyes of the wearer, but instead is formed from a single flexible unitary shield 242 forming a single protective cavity in front of and around both of the wearer’s eyes. The flexible unitary shield 242 includes a proximate edge 244 for secure and tight mounting against the frame 204, and a distal edge 246 opposite the proximate edge 244 that includes an overmolded flexible soft seal 268 created from a material having a lower durometer hardness than the material comprising the still-flexible unitary shield 242. It is also apparent that there are no contoured indentations formed within the flexible unitary shield 242, unlike the indentations formed to fit the left and right magnet mounts — 158 and 172, respectively (FIGS. 1-4) of the first embodiment. This is by virtue of the shape of the frame 204 of the sunglass assembly 202, which affords more separation between contacts and the lenses 216 and 218, and thus allows the opthalmic protector 200 to still appear sleek while accomplishing its goal of protecting a wearer’s eyes comfortably.

The flexible unitary shield 242 further includes an inner surface 248, and outer surface 250, a left lobe 252, a right lobe 254, a left magnet holder 256 comprised of the same flexible material as the shield 242 and mounted to the outer surface 250, and a right magnet holder 258 that mirrors the features of the left magnet holder 256. The left magnet holder 256 houses an embedded left magnet 258 that is positioned to magnetically seal against the left temple magnet 234, while the right magnet holder 260 houses an embedded right magnet 262 that aligns with and seals against the right temple magnet 238. Finally, the flexible unitary shield includes a center surface 264 bearing an embedded center magnet 266 that aligns and seals against the embedded center docking magnet (not shown) housed within the bridge 210. In an alternative embodiment, the flexible unitary shield 242 may further include a filtered vent port such that condensation formation may be abated on the left 218 and right 220 lenses while still preventing exposure to environmental particulates and excessive wind.

While the invention herein disclosed has been described by means of specific embodiments and applications thereof, the disclosure is illustrative only. Numerous modifications and variations could be made thereto by those skilled in the art without departing from the scope of the invention set forth in the claims.

What is claimed is:

1. An eyewear device comprising:
an eyeglass assembly comprising,
a rigid frame with a left lens opening, a right lens opening, a bridge connecting the left lens opening and right lens opening, a front surface, and a rear surface, wherein the bridge includes an embedded center docking magnet,
a left lens and a right lens,
a left nose pad and a right nose pad,
a left hinge coupled to the rigid frame on the left lens opening and a right hinge coupled to the rigid frame on the right lens opening,
an elongate left temple arm movably coupled to the rigid frame at the left hinge, wherein the elongate left temple arm includes an embedded left docking magnet, and wherein the elongate left temple arm terminates at a left temple tip opposite the left hinge, and
an elongate right temple arm movably coupled to the rigid frame at the right hinge, wherein the elongate right temple arm includes an embedded right docking magnet, and wherein the elongate right temple arm terminates at a right temple tip opposite the right hinge, and
a removable guard member comprising,
a flexible left shield extending away from the rear surface of the rigid frame at the left lens opening, having a proximate edge closest to the rear surface of the rigid frame, a distal edge furthest from the rear surface of the rigid frame, an inner surface, and an outer surface,
wherein the flexible left shield includes at least one vent, and
wherein the flexible left shield includes a left magnet coupled to the outer surface of the flexible left shield whereby the left magnet is removably attached to the embedded left docking magnet, and
a flexible right shield extending away from the rear surface of the rigid frame at the right lens opening, having a proximate edge closest to the rear surface of the rigid frame, a distal edge furthest from the rear surface of the rigid frame, an inner surface, and an outer surface,
wherein the flexible right shield includes at least one vent, and
wherein the flexible right shield includes a right magnet coupled to the outer surface of the flexible right shield whereby the right magnet is removably attached to the embedded right docking magnet,
a flexible bridge having a center magnet removably attached to the embedded center docking magnet,
a left sealing interface overmolded onto the distal edge of the flexible left shield, comprised of a material with a lower durometer hardness than the flexible shield, and
a right sealing interface overmolded onto the distal edge of the flexible left shield, comprised of a material with a lower durometer hardness than the flexible shield.

2. The eyewear device of claim 1, wherein the flexible left shield and the flexible right shield are comprised of at least one type of thermoplastic elastomer.

3. The eyewear device of claim 2, wherein the at least one type of thermoplastic elastomer is non-allergenic.

4. The eyewear device of claim 1, wherein the left soft sealing interface and the right soft sealing interface is custom manufactured to fit unique contours of a face of a user.

5. The eyewear device of claim 1, wherein the flexible bridge comprises a hinge that allows the removable guard member to fold.

6. The eyewear device of claim 5, wherein the left magnet and right magnet detachably clasp the left shield and right shield of the removable guard member when folded.

7. An eyewear device comprising:
an eyeglass assembly comprising,
a rigid frame with a left lens opening, a right lens opening, a bridge connecting the left lens opening and right lens opening, a front surface, and a rear surface, wherein the bridge includes an embedded center docking magnet,
a left lens and a right lens,
a left nose pad and a right nose pad,
a left hinge coupled to the rigid frame on the left lens opening and a right hinge coupled to the rigid frame on the right lens opening,
an elongate left temple arm movably coupled to the rigid frame at the left hinge, wherein the elongate left temple arm includes an embedded left docking magnet, and wherein the elongate left temple arm terminates at a left temple tip opposite the left hinge, and
an elongate right temple arm movably coupled to the rigid frame at the right hinge, wherein the elongate right temple arm includes an embedded right docking magnet, and wherein the elongate right temple arm terminates at a right temple tip opposite the right hinge, and
a removable guard member comprising,
a flexible shield extending away from the rear surface of the rigid frame, having a proximate edge closest to the rear surface of the rigid frame, a distal edge furthest from the rear surface of the rigid frame, an inner surface, an outer surface, a left lobe, and a right lobe,
wherein the flexible shield includes at least one vent, and
wherein the flexible shield includes a left magnet coupled to the outer surface on the left lobe whereby the left magnet is removably attached to the embedded left docking magnet, and
wherein the flexible shield includes a right magnet coupled to the outer surface of the right lobe whereby the right magnet is removably attached to the embedded right docking magnet,
a center surface having a center magnet removably attached to the embedded center docking magnet, and
a sealing interface overmolded onto the distal edge of the shield, comprised of a material with a lower durometer hardness than the flexible shield.

8. The eyewear device of claim 7, wherein the flexible shield is comprised of at least one type of thermoplastic elastomer.

9. The eyewear device of claim 8, wherein the at least one type of thermoplastic elastomer is non-allergenic.

10. The eyewear device of claim 7, wherein the sealing interface is custom manufactured to fit unique contours of a face of a user.

11. The eyewear device of claim 7, wherein the center surface comprises a hinge that allows the removable guard member to fold.

12. The eyewear device of claim 11, wherein the left magnet and right magnet detachably clasp the left lobe and right lobe of the removable guard member when folded.

13. An opthalmic guard comprising:
a flexible shield having a proximate edge contacting an inner surface of an eyeglass frame, a distal edge opposite the proximate edge, an interior surface, and an exterior surface,
wherein the flexible shield includes at least one vent,
at least one magnet, whereby the at least one magnet is selectively attachable to at least one magnet coupled to the eyeglass frame,
a flexible center bridge having a hinge, and
a sealing interface overmolded onto the distal edge of the flexible shield, comprised of a material with a lower durometer hardness than the flexible shield.

14. The opthalmic guard of claim 13, wherein the flexible shield is comprised of at least one type of thermoplastic elastomer.

15. The opthalmic guard of claim 14, wherein the at least one type of thermoplastic elastomer is non-allergenic.

16. The opthalmic guard of claim 13, wherein the sealing interface is custom manufactured to fit unique contours of a face of a user.

17. The opthalmic guard of claim 13, including at least two magnets, whereby the at least two magnets detachably clasp the ophthalmic guard member when folded.

18. An opthalmic guard comprising:
a flexible left shield having a proximate edge contacting an inner surface of an eyeglass frame around a left lens mounted within the eyeglass frame, a distal edge opposite the proximate edge, an interior surface, and an exterior surface, and wherein the flexible left shield includes at least one vent,
a flexible right shield having a proximate edge contacting an inner surface of an eyeglass frame around a right lens mounted within the eyeglass frame, a distal edge opposite the proximate edge, an interior surface, and an exterior surface, and wherein the flexible right shield includes at least one vent,
at least one magnet, whereby the at least one magnet is selectively attachable to at least one magnet coupled to the eyeglass frame,
a flexible center bridge having a hinge,
a left sealing interface overmolded onto the distal edge of the flexible left shield, comprised of a material with a lower durometer hardness than the flexible left shield, and
a right sealing interface overmolded onto the distal edge of the flexible right shield, comprised of a material with a lower durometer hardness than the flexible right shield.

19. The opthalmic guard of claim 18, wherein the flexible left shield and flexible right shield are comprised of at least one type of thermoplastic elastomer.

20. The opthalmic guard of claim 19, wherein the at least one type of thermoplastic elastomer is non-allergenic.

21. The opthalmic guard of claim 18, wherein the left sealing interface and right sealing interface are each custom manufactured to fit unique contours of a face of a user.

22. The opthalmic guard of claim 18, including at least two magnets, whereby the at least two magnets detachably clasp the ophthalmic guard member when folded.
